(19) United States
(12) Patent Application Publication
(10) Pub. No.: US 2026/0269727 A1
(43) Pub. Date: Sep. 10, 2026

(54) POWER CONVERSION DEVICE

(71) Applicant: MetaPWR Electronics Co., Ltd., Shanghai (CN)

(72) Inventors: Da Jin, Shanghai (CN); Yahong Xiong, Shanghai (CN); Qinghua Su, Shanghai (CN)

(73) Assignee: MetaPWR Electronics Co., Ltd., Shanghai (CN)

(21) Appl. No.: 19/554,657

(22) Filed: Mar. 3, 2026

(30) Foreign Application Priority Data
Mar. 5, 2025 (CN) 202510256707.7

(51) Int. Cl. H02M 3/158

(52) U.S. Cl. CPC H02M 3/158

(57) ABSTRACT

A power conversion device including an input positive terminal, an input negative terminal, an output positive terminal, an output negative terminal, a high-voltage circuit, and a low-voltage circuit is provided. The input negative terminal and the output negative terminal are short-circuited. The high-voltage circuit and the low-voltage circuit are connected to a connection point. The high-voltage circuit is connected across the input positive terminal and the connection point, and the low-voltage circuit is connected across the connection point and the output negative terminal. The power conversion device further comprises a first control signal, a second control signal, a third control signal and a fourth control signal. The first control signal and the second control signal are 180 degrees phase-shift, the third control signal is complementary to the first control signal, and the fourth control signal is complementary to the second control signal.

### CROSS-REFERENCE TO RELATED APPLICATION

This application claims the priority benefit of China application serial no. 202510256707.7 filed on Mar. 5, 2025. The entirety of the above-mentioned patent application is hereby incorporated by reference herein and made a part of this specification.

### BACKGROUND

### Description of Related Art

With the development of artificial intelligence, the power requirements of artificial intelligence data processing chips, such as CPU, GPU, TPU, etc. (collectively, xPU) are increasingly high, so that the power of the server is increased, and the power supply voltage of the server system board rises from 12V to 48V. In application where the power supply voltage of the server system board is 48V, the two-stage step-down circuit architecture gradually changes to the mainstream.

The intermediate bus conversion apparatus in the two-stage step-down circuit architecture is used for implementing voltage conversion between an input bus and an output bus, and the ratio of the input voltage to the output voltage is two types of fixed ratio or unfixed ratio. According to the present disclosure, for the intermediate bus conversion device, by means of optimizing the control strategy, a big ratio range of the input voltage to the output voltage is achieved, and stable output requirements of different input voltages or different output voltages are met. In addition, the present disclosure further optimizes the structural layout, reduces parasitic parameters, and meets the increasing conversion efficiency requirements of the power conversion device.

### SUMMARY

In view of the above, one of the objectives of the disclosure is to provide a power conversion device, comprising an input positive terminal, an input negative terminal, an output positive terminal, an output negative terminal, a high-voltage circuit, and a low-voltage circuit, wherein the input negative terminal and the output negative terminal are short-circuited; the high-voltage circuit and the low-voltage circuit are connected to a connection point; the high-voltage circuit is connected across the input positive terminal and the connection point, and the low-voltage circuit is connected across the connection point and the output negative terminal.

The high-voltage circuit comprises a first high-voltage bridge arm and a second high-voltage bridge arm, and the first high-voltage bridge arm and the second high-voltage bridge arm are connected in parallel and then connected between the input positive terminal and the connection point; the first high-voltage bridge arm comprises a first upper switch and a first middle switch electrically connected in series, and the second high-voltage bridge arm comprises a second upper switch and a second middle switch electrically connected in series;

The low-voltage circuit comprises a first low-voltage bridge arm and a second low-voltage bridge arm, and the first low-voltage bridge arm and the second low-voltage bridge arm are connected in parallel and then connected between the connection point and the input negative terminal; the first low-voltage bridge arm comprises a first main switch and a first lower switch electrically connected in series, and the second low-voltage bridge arm comprises a second main switch and a second lower switch electrically connected in series; the first middle switch, the first main switch, the second middle switch, and the second main switch are all electrically connected to the connection point.

The power conversion device further comprises a first control signal, a second control signal, a third control signal and a fourth control signal; the first control signal and the second control signal are 180 degrees phase-shift, the third control signal is complementary to the first control signal, and the fourth control signal is complementary to the second control signal;

The first main switch is controlled to be turned on and turned off by the first control signal or the fourth control signal, and the second main switch is controlled to be turned on and turned off by the second control signal or the third control signal; a duty cycle of the first main switch and the second main switch is any value between 0 and 1.

Preferably, the duty cycle of the first main switch and the second main switch is less than or equal to 0.5; the first control signal is used for controlling the turn-on and turn-off of the first upper switch, the second middle switch and the first main switch; the second control signal is used for controlling the turn-on and turn-off of the second upper switch, the first middle switch and the second main switch; the third control signal is used for controlling the turn-on and turn-off of the first lower switch; and the fourth control signal is used for controlling the turn-on and turn-off of the second lower switch.

Preferably, the duty cycle of the first main switch and the second main switch is greater than 0.5; the first control signal is used for controlling the turn-on and turn-off of the first upper switch, the second middle switch and the second lower switch; the second control signal is used for controlling the turn-on and turn-off of the second upper switch, the first middle switch and the first lower switch; the third control signal is used for controlling the turn-on and turn-off of the second main switch; the fourth control signal is used for controlling the turn-on and turn-off of the first main switch.

Preferably, the power conversion device is controlled by a fixed duty cycle.

Preferably, the power conversion device is controlled by an adjustable duty cycle.

Preferably, further comprising a first input capacitor and a second input capacitor, wherein the first input capacitor is connected across the input positive terminal and the connection point, and the second input capacitor is connected between the connection point and the input negative terminal.

Preferably, the first upper switch and the first middle switch are connected to a first upper node, and the second upper switch and the second middle switch are connected to a second upper node; the high-voltage circuit further comprises a high-voltage winding, a first end of the high-voltage winding is connected to the first upper node, and a second end of the high-voltage winding is connected to the second upper node; the low-voltage circuit further comprises a first low-voltage winding and a second low-voltage winding; the first main switch and the first lower switch are connected to a first lower node, and the second main switch and the second lower switch are connected to a second lower node; a first end of the first low-voltage winding is electrically connected to the first lower node, a first end of the second low-voltage winding is electrically connected to the second lower node, and a second end of the first low-voltage winding is connected with a second end of the second low-voltage winding.

Preferably, the high-voltage winding, the first low-voltage winding and the second low-voltage winding constitute a transformer, the first end of the high-voltage winding, the first end of the first low-voltage winding, and the second end of the second low-voltage winding have the same polarity.

Preferably, the low-voltage circuit further comprises an output inductor, a first end of the output inductor is electrically connected to the second end of the first low-voltage winding and the second end of the second low-voltage winding, and a second end of the output inductor is electrically connected to the output positive terminal.

One of the objectives of the disclosure is to provide a power conversion device, comprising an input positive terminal, an input negative terminal, an output positive terminal, an output negative terminal, a high-voltage circuit, and a low-voltage circuit, wherein the input negative terminal and the output negative terminal are connected; the high-voltage circuit is connected across the input positive terminal and a connection point, and the low-voltage circuit is connected across the connection point and the output negative terminal; the high-voltage circuit comprises a first high-voltage bridge arm, a second high-voltage bridge arm, a first input capacitor, and a high-voltage winding; the low-voltage circuit comprises a first low-voltage bridge arm, a second low-voltage bridge arm, a second input capacitor, a first low-voltage winding, a second low-voltage winding, and an output capacitor.

The power conversion device further comprises a transformer magnetic core, wherein the high-voltage winding, the first low-voltage winding and the second low-voltage winding are coupled by means of the transformer magnetic core; the transformer magnetic core comprises a first side and a third side opposite to each other; the first high-voltage bridge arm and the second high-voltage bridge arm of the high-voltage circuit are arranged adjacent to the first side of the transformer magnetic core; the first low-voltage bridge arm and the second low-voltage bridge arm of the low-voltage circuit are arranged adjacent to the third side of the transformer magnetic core.

The power conversion device further comprises a circuit board, wherein the circuit board comprises a top surface and a bottom surface opposite to each other, a hole and/or a hole groove, and the hole and/or the hole groove penetrate through the top surface and the bottom surface; the transformer magnetic core part passes through the hole and/or the hole groove and is assembled to the circuit board; and the wiring of the connection point is arranged on the circuit board and outside of the transformer magnetic core.

Preferably, the first high-voltage bridge arm and the second high-voltage bridge arm are connected in parallel and then connected between the input positive terminal and the connection point, and the first low-voltage bridge arm and the second low-voltage bridge arm are connected in parallel and then connected between the connection point and the input negative terminal; each of the high-voltage bridge arms comprises two switches electrically connected in series; a first end of the high-voltage winding is electrically connected to a midpoint of the first high-voltage bridge arm, and a second end of the high-voltage winding is electrically connected to a midpoint of the second high-voltage bridge arm; the first low-voltage bridge arm comprises a first main switch and a first lower switch electrically connected in series, and the first main switch and the first lower switch are electrically connected to a first lower node; the second low-voltage bridge arm comprises a second main switch and a second lower switch electrically connected in series, and the second main switch and the second lower switch are electrically connected to a second lower node; a first end of the first low-voltage winding is electrically connected to the first lower node, a first end of the second low-voltage winding is electrically connected to the second lower node, and a second end of the first low-voltage winding is connected to a second end of the second low-voltage winding; and the first end of the high-voltage winding, the first end of the first low-voltage winding, and the second end of the second low-voltage winding have the same polarity.

Preferably, the circuit board comprises three holes, the three holes are sequentially arranged in the same direction, and a channel formed between every two adjacent holes is a first channel and a second channel, respectively; two switches of the first high voltage bridge arm are disposed adjacent to the first channel, the first lower switch is disposed adjacent to the second channel, two switches of the second high voltage bridge arm are disposed adjacent to the second channel, and the second lower switch is disposed adjacent to the first channel.

Preferably, the two switches of the first high-voltage bridge arm are horizontally arranged along the X-axis or vertically arranged along the Y-axis, and the two switches of the second high-voltage bridge arm are horizontally arranged along the X-axis or vertically arranged along the Y-axis; the first input capacitor is disposed on two opposite sides of two switches of the first high-voltage bridge arm and/or two opposite sides of two switches of the second high-voltage bridge arm, or the first input capacitor is disposed between the first high-voltage bridge arm and the second high-voltage bridge arm.

Preferably, the first input capacitor is disposed on the bottom surface of the circuit board, and a projection of the first input capacitor on the circuit board and a projection of the switch of the high-voltage circuit on the circuit board at least partially overlap.

Preferably, the power conversion device further comprises an output inductor, a first end of the output inductor is electrically connected to a second end of the first low-voltage winding and a second end of the second low-voltage winding, and a second end of the output inductor is electrically connected to an output positive terminal; the power conversion device further includes an inductor magnetic core disposed adjacent to a third side of the transformer magnetic core. Preferably, the first lower switch is disposed adjacent to the first main switch, and the second lower switch is disposed adjacent to the second main switch; the first lower switch is disposed between the transformer magnetic core and the first main switch, and the second lower switch is disposed between the transformer magnetic core and the second main switch.

Preferably, the second input capacitor is disposed adjacent to the first main switch and the first lower switch and/or the second input capacitor is disposed adjacent to the second main switch and the second lower switch.

Preferably, the second input capacitor is disposed on the bottom surface of the circuit board, and a projection of the second input capacitor on the circuit board at least partially overlaps with a projection of the first main switch and the second main switch on the circuit board.

Preferably, both the first lower switch and the second lower switch comprise two switches connected in parallel, the two switches connected in parallel are respectively arranged on the top surface and the bottom surface of the circuit board, and projections of the two parallel switches on the circuit board at least partially overlap.

Preferably, the input positive terminal and the input negative terminal are disposed adjacent to two switches of the first high-voltage bridge arm and/or two switches of the second high-voltage bridge arm; and the output positive terminal and the output negative terminal are disposed adjacent to the first main switch and/or the second main switch, and the output capacitor is disposed between the output positive terminal and the output negative terminal.

Compared with the prior art, the disclosure has the following beneficial effects:

The present disclosure provides a control strategy, which can achieve a large ratio range between an input voltage and an output voltage, and meet requirements of different output voltages.

The present disclosure further provides a structural layout, which reduces the loss caused by parasitic parameters in the power conversion device by providing the positional relationship between the switch in the high-voltage circuit, the switch in the low-voltage circuit and the transformer, thereby improving the conversion efficiency of the power conversion device.

### BRIEF DESCRIPTION OF THE DRAWINGS

FIG. 1 is a schematic topology diagram of a power conversion device.

FIG. 2 is a control strategy applicable to the topology of FIG. 1.

FIG. 3A to FIG. 3C are structural layouts according to an embodiment.

FIG. 4 is a structural layout of another embodiment.

### DESCRIPTION OF THE EMBODIMENTS

One of the cores of the present disclosure is to provide a power conversion device, including a topology schematic diagram and a control strategy, which further optimizes the structural layout of the power conversion device, reduces parasitic parameters in the device, and improves the conversion efficiency of the power conversion device.

Technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

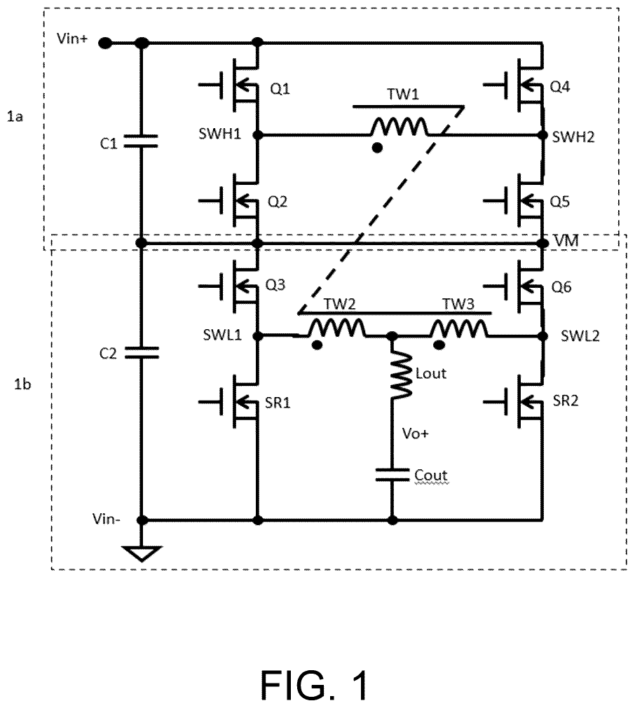

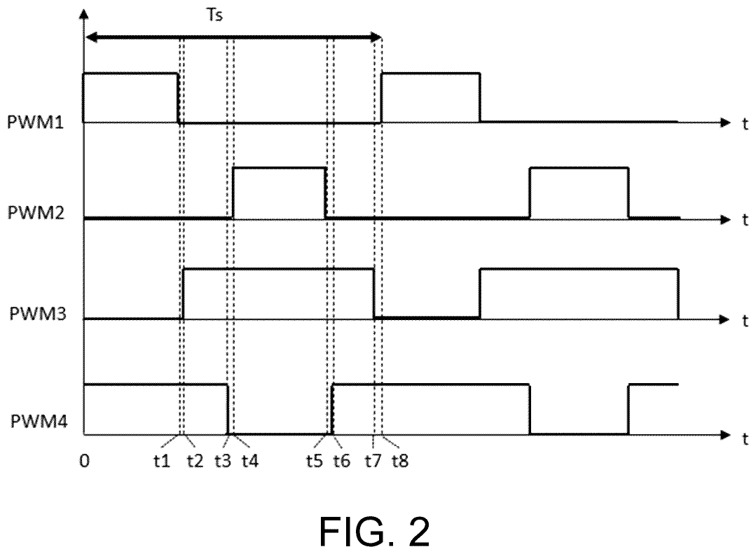

Disclosed in the present disclosure are a topology and control strategy for a power conversion device, as shown in FIG. 1 and FIG. 2. FIG. 1 is a schematic diagram of a topology of the power conversion device, and FIG. 2 is a control strategy applicable to the topology of FIG. 1. In detail, the topology of the power conversion device comprises an input positive terminal Vin+, an input negative terminal Vin−, an output positive terminal Vo+, an output negative terminal Vo−, a high voltage circuit 1a, and a low voltage circuit 1b. In this embodiment, the input negative terminal Vin− and the output negative terminal Vo− are shorted. The high-voltage circuit 1a and the low-voltage circuit 1b are shorted to a connection point VM, the high-voltage circuit 1a is connected across the input positive terminal Vin+ and the connection point VM, and the low-voltage circuit 1b is connected between the connection point VM and the input negative terminal Vin−. The high-voltage circuit 1a comprises a first high-voltage bridge arm, a second high-voltage bridge arm, a first input capacitor C1 and a high-voltage winding TW1, wherein the first input capacitor C1, the first high-voltage bridge arm and the second high-voltage bridge arm are connected in parallel and then connected between the input positive terminal Vin+ and the connection point VM. The first high-voltage bridge arm comprises a first upper switch Q1 and a first middle switch Q2 electrically connected in series; the first upper switch Q1 and the first middle switch Q2 are shorted to a first upper node SWH1 (i.e., a midpoint in the first high-voltage bridge arm); the second high-voltage bridge arm comprises a second upper switch Q4 and a second middle switch Q5 electrically connected in series; the second upper switch Q4 and the second middle switch Q5 are shorted to a second upper node SWH2 (i.e., a midpoint in the second high-voltage bridge arm); the high-voltage winding TW1 is connected between the first upper node SWH1 and the second upper node SWH2. A first end of the high-voltage winding TW1 is short-circuited to the first upper node SWH1, and a second end of the high-voltage winding TW1 is shorted to the second upper node SWH2.

The low-voltage circuit 1b comprises a first low-voltage bridge arm, a second low-voltage bridge arm, a second input capacitor C2, a first low-voltage winding TW2, a second low-voltage winding TW3, an output inductor Lout and an output capacitor Co. The second input capacitor C2, the first low-voltage bridge arm and the second low-voltage bridge arm are connected in parallel and then connected between the connection point VM and the input negative terminal Vin−. The first low-voltage bridge arm comprises a first main switch Q3 and a first lower switch SR1 electrically connected in series; the first main switch Q3 and the first lower switch SR1 are shorted to a first lower node SWL1; the second low-voltage bridge arm comprises a second main switch Q6 and a second lower switch SR2 electrically connected in series; the second main switch Q6 and the second lower switch SR2 are shorted to a second lower node SWL2; the first end of the first low-voltage winding TW2 is electrically connected to the first lower node SWL1, the first end of the second low-voltage winding TW3 is electrically connected to the second lower node SWL2, the second end of the first low-voltage winding TW2 and the second end of the second low-voltage winding TW3 are electrically connected to the first end of the output inductor Lout, and the second end of the output inductor Lout is electrically connected to the output positive terminal Vo+; the output capacitor Co is connected across the output positive terminal Vo+ and the output negative terminal Vo− (i.e., the input negative terminal Vin−). The high-voltage winding TW1, the first low-voltage winding TW2, and the second low-voltage winding TW3 are coupled. The first end (i.e., the first upper node SWH1) of the high-voltage winding TW1, the first end of the first low-voltage winding TW2, and the second end of the second low-voltage winding TW3 have the same polarity, and are marked as point ends.

The control strategy disclosed in the present disclosure is as shown in FIG. 2, comprising a first control signal PWM1, a second control signal PWM2, a third control signal PWM3 and a fourth control signal PWM4. In the same switching period Ts, the first control signal PWM1 and the second control signal PWM2 are 180 degrees out of phase; ignoring the dead zone intervals t1-t2 and t7-t8, the third control signal PWM3 and the first control signal PWM1 are complementary; and ignoring the dead zone intervals t3-t4 and t5-t6, the fourth control signal PWM4 and the second control signal PWM2 are complementary.

In the circuit topology shown in FIG. 1, the duty cycle of the first main switch Q3 and the second main switch Q6 is the duty cycle of the power conversion device. When the duty cycle D of the power conversion device is less than or equal to 0.5, the first control signal PWM1 is used for controlling the turn-on and turn-off of the first upper switch Q1, the second middle switch Q5 and the first main switch Q3; the second control signal PWM2 is used for controlling the turn-on and turn-off of the second upper switch Q4, the first middle switch Q2 and the second main switch Q6; the third control signal PWM3 is used for controlling the turn-on and turn-off of the first lower switch SR1, and the fourth control signal PWM4 is used for controlling the turn-on and turn-off of the second lower switch SR2. The turn ratio of the high-voltage winding TW1 and the low-voltage winding TW2 and TW3 is N:1:1. The first input capacitor C1 and the second input capacitor C2 are electrically connected to the connection point and then connected in series between the input positive terminal Vin+ and the input negative terminal Vin−. In this embodiment, the voltage VC1 across the first input capacitor and the voltage VC2 across the second input capacitor satisfy the expression VC1:VC2=N:2 (N is a positive integer), so that the input voltage Vin and the output voltage Vo satisfy the following relationship:

$$( ( VC 2 - \frac{VC 1}{N} ) - Vo ) \cdot D = Vo \cdot ( 0.5 - D )$$

After simplification, it is:

$$Vo = Vin \cdot \frac{2}{N + 2} \cdot D$$

In this embodiment, the turns ratio of the high-voltage winding TW1 and the low-voltage winding TW2 and TW3 is 2:1:1, that is, N=2, so Vo=Vin·D/2; furthermore, when D=0.5, Vo=Vin/4; that is, when the input voltage Vin is 48V, the output voltage Vo is 12V.

When the duty cycle D>0.5 of the power conversion device, the first control signal PWM1 is used for controlling the turn-on and turn-off of the first upper switch Q1, the second middle switch Q5, and the second lower switch SR2; the second control signal PWM2 is used for controlling the turn-on and turn-off of the second upper switch Q4, the first middle switch Q2 and the first lower switch SR1; the third control signal PWM3 is used for controlling the turn-on and turn-off of the second main switch Q6; and the fourth control signal PWM4 is used for controlling the turn-on and turn-off of the first main switch Q3. The turns ratio of the high-voltage winding TW1 and the low-voltage winding TW2 and TW3 is N:1:1. In this embodiment, the voltage VC1 across the first input capacitor and the voltage VC2 across the second input capacitor satisfy the expression VC1:VC2=N:2 (Nis a positive integer), so that the input voltage Vin and the output voltage Vo satisfy the following relationship:

$$( VC 2 - Vo ) \cdot ( D - 0.5 ) = ( Vo - VC 2 + \frac{VC 1}{N} ) \cdot ( 1 - D )$$

After simplification, it is:

$$Vo = Vin \cdot \frac{2}{N + 2} \cdot D$$

In this embodiment, the turns ratio of the high-voltage winding TW1 and the low-voltage winding TW2 and TW3 is 2:1:1, that is, N=2, so Vo=Vin·D/2; furthermore, when D>0.5, Vo>Vin/4; that is, when the input voltage Vin is less than 48V, the output voltage Vo can also be equal to or greater than 12V.

Furthermore, the circuit topology and the control strategy disclosed in the present disclosure can enable the power conversion device to operate in a fixed duty cycle working state, and the duty cycle D can be any value between 0 and 1; or the power conversion device can work in a duty cycle adjustable state, and the duty cycle D can be adjusted between 0 and 1. In other embodiments, in order to obtain a larger input voltage and output voltage ratio, N may also be any value greater than 2.

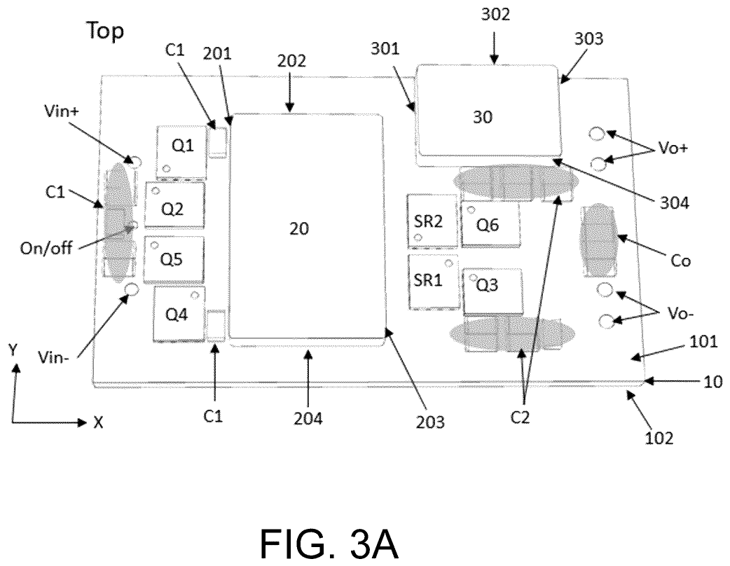

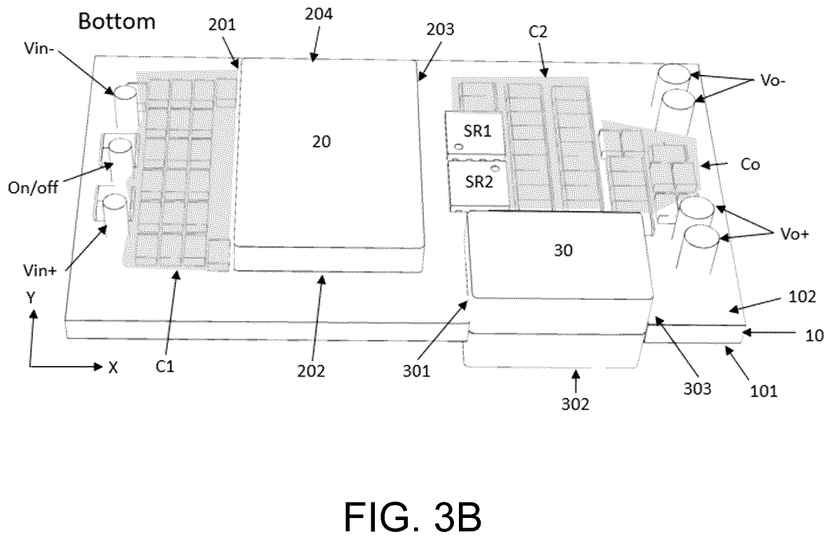

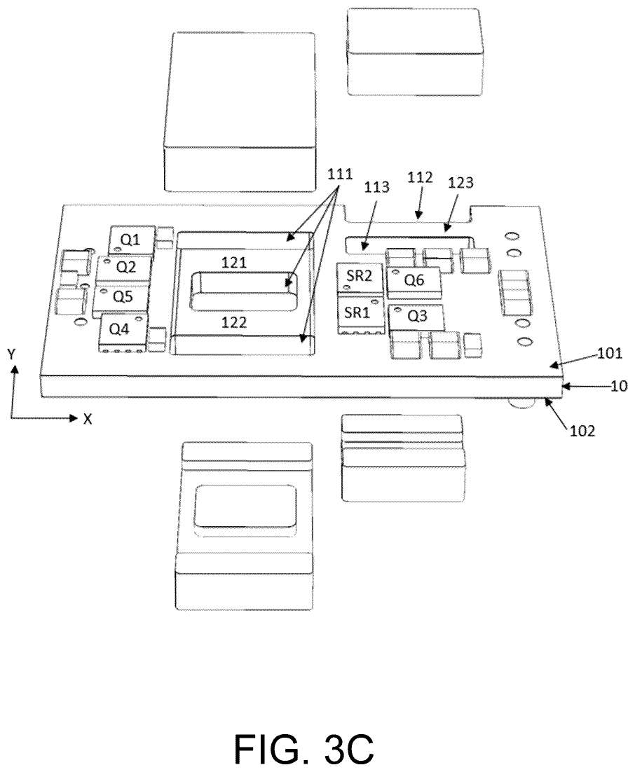

On the other hand, the present disclosure further discloses an optimized layout of the power conversion device, as shown in FIG. 3A to FIG. 3C. FIG. 3A is a schematic top view of the power conversion device, FIG. 3B is a schematic bottom view of the power conversion device, and FIG. 3C is an exploded schematic diagram of the power conversion device.

With reference to FIG. 3A to 3C, the power conversion device comprises a circuit board 10, and the circuit board 10 comprises a top surface 101 and a bottom surface 102 opposite to each other. The power conversion device further comprises a transformer magnetic core 20 and an inductor magnetic core 30, wherein both the transformer magnetic core 20 and the inductor magnetic core 30 comprise an upper magnetic cover, a lower magnetic cover and a plurality of magnetic columns. The circuit board 10 further comprises holes 111 and 113 and/or hole grooves 112, which are respectively used for the magnetic columns of the transformer magnetic core 20 and the magnetic columns of the inductor magnetic core 30 to pass through, and the corresponding upper magnetic cover and lower magnetic cover are assembled to the circuit board respectively. After the transformer magnetic core 20 and the inductor magnetic core 30 are assembled to the circuit board 10, the transformer magnetic core 20 comprises a first side 201, a second side 202, a third side 203 and a fourth side 204, and the four sides are in a clockwise direction; the first side 201 and the third side 203 are opposite to each other, and the second side 202 and the fourth side 204 are opposite to each other. The inductor magnetic core 30 comprises a first side 301, a second side 302, a third side 303 and a fourth side 304, the four sides are in a clockwise direction; wherein the first side 301 and the third side 303 are opposite, the second side 302 and the fourth side 304 are opposite. The third side 203 of the transformer magnetic core 20 and the first side 301 of the inductive magnetic core 30 are adjacent to each other.

On the top surface 101 of the circuit board 10, the switches Q1, Q2, Q4 and Q5 in the high voltage circuit 1a are arranged adjacent to the first side 201 of the transformer magnetic core 20, and the switches Q3, Q6, SR1 and SR2 in the low voltage circuit 1b are arranged adjacent to the third side 203 of the transformer magnetic core 20. The high-voltage winding TW1, the first low-voltage winding TW2, and the second low-voltage winding TW3 are all arranged in the circuit board 10 and are coupled by means of the transformer magnetic core 20. The first end and the second end of the high-voltage winding TW1 are disposed adjacent to the first side 201 of the transformer magnetic core 20, that is, adjacent to the switches Q1, Q2, Q4 and Q5 in the high-voltage circuit 1a. Both the first ends and the second ends of the first low-voltage winding TW2 and the second low-voltage winding TW3 are disposed adjacent to the third side 203 of the transformer magnetic core 20, that is, adjacent to the switches Q3, Q6, SR1 and SR2 in the low-voltage circuit 1b. The switches Q1, Q2, Q5, and Q4 in the high-voltage circuit 1a are adjacent to the first side 201 of the transformer magnetic core 20 and arranged in a row and adjacent to each other; the first middle switch Q2 and the second middle switch Q5 are arranged adjacent to each other, and the source of the first middle switch Q2 and the source of the second middle switch Q5 are adjacent and short-circuited to each other; the first upper switch Q1 and the second upper switch Q4 are arranged on two sides of the short-circuited first middle switch Q2 and second middle switch Q5. The plurality of first input capacitors C1 are respectively arranged on two opposite sides of the first upper switch Q1 and the first middle switch Q2, and are arranged adjacent to the first upper switch Q1 and the first middle switch Q2, so that the loop formed by the first input capacitors C1, the first upper switch Q1 and the first middle switch Q2 is minimized, thereby reducing the parasitic inductance of the loop, so that the voltage spike of the voltage drop Vds across the first upper switch Q1 and/or the first middle switch Q2 is further reduced. Similarly, the plurality of the first input capacitors C1 are respectively arranged on two opposite sides of the second upper switch Q4 and the second middle switch Q5, and are arranged adjacent to the second upper switch Q4 and the second middle switch Q5, so that the loop formed by the first input capacitors C1, the second upper switch Q4, and the second middle switch Q5 is minimized, so that the voltage spike of the voltage drop Vds across the second upper switch Q4 and/or the second middle switch Q5 is further reduced.

The first lower switch SR1 and the second lower switch SR2 in the low voltage circuit 1b are both disposed adjacent to the third side 203 of the transformer magnetic core 20, and the source electrode of the first lower switch SR1 and the source electrode of the second lower switch SR2 are disposed adjacent to and shorted. The first main switch Q3 is disposed adjacent to the first lower switch SR1, and the first lower switch SR1 is disposed between the transformer magnetic core 20 and the first main switch Q3. The second main switch Q6 is disposed adjacent to the second lower switch SR2, and the second lower switch SR2 is disposed between the transformer magnetic core 20 and the second main switch Q6. The plurality of second input capacitors C2 are arranged adjacent to the first main switch Q3 and the first lower switch SR1, so that the loop formed by the second input capacitors C2, the first main switch Q3 and the first lower switch SR1 is minimized, thereby reducing the parasitic inductance of the loop, so that the voltage spike of the voltage drop Vds across the first main switch Q3 and/or the first lower switch SR1 is further reduced. Similarly, the plurality of second input capacitors C2 are respectively arranged in the second main switch Q6 and the second lower switch SR2, so that the loop formed by the second input capacitors C2, the second main switch Q6 and the second lower switch SR2 are minimized, so that the voltage spike of the voltage drop Vds across the second main switch Q6 and/or the second lower switch SR2 is further reduced. Furthermore, “be disposed adjacent to” can be “adjoin” here, the distance of the two can be shorter.

The output inductor Lout in the low voltage circuit 1b is disposed adjacent to the second side 202 and the third side 203 of the transformer magnetic core 20 and is disposed adjacent to the second lower switch SR2. Further, the power conversion device further comprises an input terminal and an output terminal, the input terminal comprises the input positive terminal Vin+ and the input negative terminal Vin−, and the output terminal comprises the output positive terminal Vo+ and the output negative terminal Vo−. Both the input terminal and the output terminal are arranged adjacent to the edge of the power conversion device, and the input terminal is arranged adjacent to the switch of the high-voltage circuit 1a; and the switch of the high-voltage circuit 1a is arranged between the input terminal and the first side 201 of the transformer magnetic core 20. The output terminal is arranged adjacent to the switch of the low-voltage circuit 1b; the switch of the low-voltage circuit 1b is arranged between the output terminal and the third side 203 of the transformer magnetic core 20. The inductor magnetic core 30 is arranged between the transformer magnetic core 20 and the output terminal. A plurality of output capacitors Co are disposed between the output positive terminal Vo+ and the output negative terminal Vo−.

On the bottom surface 102 of the circuit board, a plurality of first input capacitors C1 are provided in a region vertically corresponding to where the switch of the high-voltage circuit 1a is disposed. Another first lower switch SR1 is provided on the bottom surface 102 of the circuit board in a vertical corresponding region of the first lower switch SR1, and is electrically connected in parallel to the first lower switch SR1 on the top surface 101. And another second lower switch SR2 is arranged on the bottom surface 102 of the circuit board in a vertical corresponding region of the second lower switch SR2, and is electrically connected in parallel with the second lower switch SR2 on the top surface 101. A plurality of second input capacitors C2 are provided on the bottom surface 102 of the circuit board in vertical corresponding regions of the first main switch Q3 and the second main switch Q6. And on the bottom surface 102 of the circuit board, the plurality of output capacitors Co are also arranged between the output positive terminal Vo+ and the output negative terminal Vo−. The circuit board wiring corresponding to the connection point VM is arranged on the outer side of the first side 201 or the outer side of the third side 203 of the transformer magnetic core 20. The connection point VM electrically connects the high-voltage circuit 1a and the low-voltage circuit 1b together in the circuit board of a corresponding area.

As shown in FIG. 3C, a circuit board area between two adjacent holes 111 is a first channel 121 and a second channel 122, respectively, and the first channel 121 and the second channel 122 are respectively used for the high-voltage winding TW1 and the low-voltage winding TW2 and TW3 to pass through; a circuit board area between the hole 113 and the hole groove 112 is an inductor winding channel 123, and the inductor winding channel 123 is used for the output inductor winding to pass through. The first upper switch Q1 and the first middle switch Q2 are disposed adjacent to the first channel 121, and the first lower switch SR1 is disposed adjacent to the second channel 122, so that the first end of the high voltage winding TW1 (i.e., one end that is shorted to the source of the first upper switch Q1) and the first end of the first low voltage winding TW2 (i.e., one end that is shorted to the drain of the first lower switch SR1) have the same polarity. The second upper switch Q4 and the second middle switch Q5 are disposed adjacent to the second channel 122, and the second lower switch SR2 is disposed adjacent to the first channel 121, so that the second end of the high voltage winding TW1 (i.e., one end that is shorted to the source of the second upper switch Q4) and the first end of the second low voltage winding TW3 (i.e., one end that is shorted to the drain of the second lower switch SR2) have the same polarity. The second end of the first low-voltage winding TW2 and the second end of the second low-voltage winding TW3 are shorted to pass through the third channel 123 of the inductor magnetic core 30, and are electrically connected to the output positive terminal Vo+, thereby further reducing the parasitic resistance of the output inductor Lout and reducing the loss of the power conversion device.

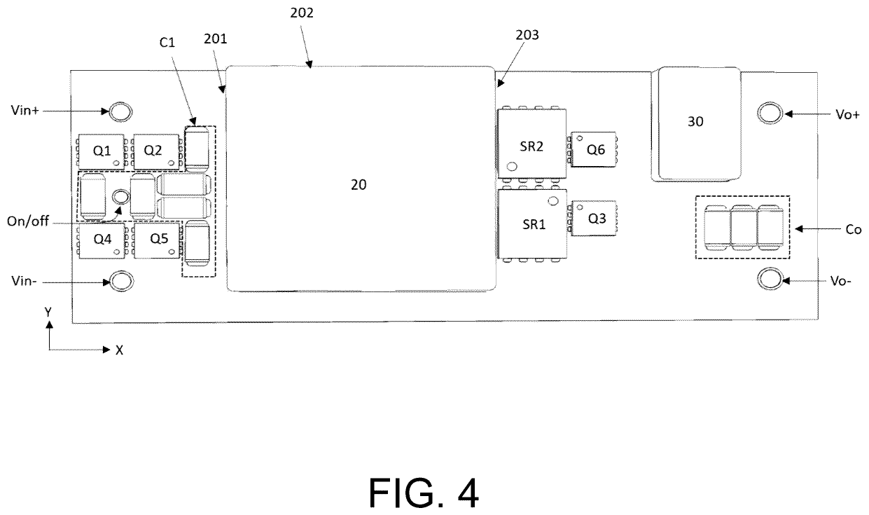

The embodiment of FIG. 3A to FIG. 3C satisfy the size of a quarter-brick, and FIG. 4 shows another embodiment satisfying the size of one-eighth brick. The length of the corresponding power conversion device is unchanged (i.e., the size of the X-axis direction), the width is reduced (i.e., the size of the Y-axis direction), and the output power of the power conversion device is also reduced. Similar to the layout of FIG. 3A, the switch in the high-voltage circuit 1a is arranged adjacent to the first side 201 of the transformer magnetic core 20, and the switch in the low-voltage circuit 1b is arranged adjacent to the third side 203 of the transformer magnetic core 20. Specifically, along the X-axis direction, from left to right, there are: the switch in the high-voltage circuit 1a, the transformer magnetic core 20, the switch in the low-voltage circuit 1b, the output inductor Lout in the low-voltage circuit, and the output capacitor Co. The first upper switch Q1 and the first middle switch Q2 are arranged along the X-axis direction from left to right. The source of the first upper switch Q1 and the drain of the first middle switch Q2 are disposed adjacent to each other and electrically connected; the second upper switch Q4 and the second middle switch Q5 are arranged along the X-axis direction; and the source of the second upper switch Q4 is disposed adjacent to and electrically connected to the drain of the second middle switch Q5. A plurality of first input capacitors C1 are disposed between the first upper switch Q1 and the second upper switch Q4, or are disposed between the first middle switch Q2 and the second middle switch Q5, so that a loop formed by the first output capacitor C1, the first upper switch Q1, and the first middle switch Q2 is minimized; and a loop formed by the first output capacitor C1, the second upper switch Q4, and the second middle switch Q5 is minimized, thereby further reducing a voltage spike of the voltage Vds across the switch when the switch is turned off. Similarly, the circuit board wiring corresponding to the connection point VM is adjacent to the outer side of the first side 201 or the outer side of the third side 203 of the transformer magnetic core 20. The connection point VM electrically connects the high-voltage circuit 1a and the low-voltage circuit 1b together in a circuit board of a corresponding area. For other technical features, refer to FIG. 3A to FIG. 3C, and details are not described herein again.

The switches disclosed by the application can be used for realizing the functions of the switch disclosed by the application, such as a Si MOSFET, SiC MOSFET, GaN MOSFET or IGBT MOSFET.

The power supply module device according to the embodiment can be an independent module or a part of the electronic device, and can meet the technical features and advantages disclosed by the application.

The “equal” or “same” or “equal to” disclosed by the application needs to consider the parameter distribution of engineering, and the error distribution is within +/−30%; and the included angle between the two line segments or the two straight lines is less than or equal to 45 degrees; the included angle between the two line segments or the two straight lines is within the range of [60, 120]; and the definition of the phase error phase also needs to consider the parameter distribution of the engineering, and the error distribution of the phase error degree is within +/−30%.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. A power conversion device, comprising:
an input positive terminal, an input negative terminal, an output positive terminal, an output negative terminal, a high-voltage circuit, and a low-voltage circuit,
wherein the input negative terminal and the output negative terminal are short-circuited; the high-voltage circuit and the low-voltage circuit are connected to a connection point; the high-voltage circuit is connected across the input positive terminal and the connection point, and the low-voltage circuit is connected across the connection point and the output negative terminal;
the high-voltage circuit comprises a first high-voltage bridge arm and a second high-voltage bridge arm, and the first high-voltage bridge arm and the second high-voltage bridge arm are connected in parallel and then connected between the input positive terminal and the connection point; the first high-voltage bridge arm comprises a first upper switch and a first middle switch electrically connected in series, and the second high-voltage bridge arm comprises a second upper switch and a second middle switch electrically connected in series;
the low-voltage circuit comprises a first low-voltage bridge arm and a second low-voltage bridge arm, and the first low-voltage bridge arm and the second low-voltage bridge arm are connected in parallel and then connected between the connection point and the input negative terminal; the first low-voltage bridge arm comprises a first main switch and a first lower switch electrically connected in series, and the second low-voltage bridge arm comprises a second main switch and a second lower switch electrically connected in series; the first middle switch, the first main switch, the second middle switch, and the second main switch are all electrically connected to the connection point;
wherein the power conversion device further comprises a first control signal, a second control signal, a third control signal and a fourth control signal; the first control signal and the second control signal are 180 degrees phase-shift, the third control signal is complementary to the first control signal, and the fourth control signal is complementary to the second control signal;
wherein the first main switch is controlled to be turned on and turned off by the first control signal or the fourth control signal, and the second main switch is controlled to be turned on and turned off by the second control signal or the third control signal;
wherein a duty cycle of the first main switch and the second main switch is any value between 0 and 1.

2. The power conversion device of claim 1, wherein the duty cycle of the first main switch and the second main switch is less than or equal to 0.5;
the first control signal is used for controlling the turn-on and turn-off of the first upper switch, the second middle switch and the first main switch; the second control signal is used for controlling the turn-on and turn-off of the second upper switch, the first middle switch and the second main switch; the third control signal is used for controlling the turn-on and turn-off of the first lower switch; and the fourth control signal is used for controlling the turn-on and turn-off of the second lower switch.

3. The power conversion device of claim 1, wherein the duty cycle of the first main switch and the second main switch is greater than 0.5; the first control signal is used for controlling the turn-on and turn-off of the first upper switch, the second middle switch and the second lower switch; the second control signal is used for controlling the turn-on and turn-off of the second upper switch, the first middle switch and the first lower switch; the third control signal is used for controlling the turn-on and turn-off of the second main switch; the fourth control signal is used for controlling the turn-on and turn-off of the first main switch.

4. The power conversion device of claim 1, wherein the power conversion device is controlled by a fixed duty cycle.

5. The power conversion device of claim 1, wherein the power conversion device is controlled by an adjustable duty cycle.

6. The power conversion device of claim 1, further comprising a first input capacitor and a second input capacitor, wherein the first input capacitor is connected across the input positive terminal and the connection point, and the second input capacitor is connected between the connection point and the input negative terminal.

7. The power conversion device of claim 1, wherein the first upper switch and the first middle switch are connected to a first upper node, and the second upper switch and the second middle switch are connected to a second upper node;
the high-voltage circuit further comprises a high-voltage winding, a first end of the high-voltage winding is connected to the first upper node, and a second end of the high-voltage winding is connected to the second upper node;
the low-voltage circuit further comprises a first low-voltage winding and a second low-voltage winding; the first main switch and the first lower switch are connected to a first lower node, and the second main switch and the second lower switch are connected to a second lower node;
a first end of the first low-voltage winding is electrically connected to the first lower node, a first end of the second low-voltage winding is electrically connected to the second lower node, and a second end of the first low-voltage winding is connected with a second end of the second low-voltage winding.

8. The power conversion device of claim 7, wherein the high-voltage winding, the first low-voltage winding and the second low-voltage winding constitute a transformer, the first end of the high-voltage winding, the first end of the first low-voltage winding, and the second end of the second low-voltage winding have the same polarity.

9. The power conversion device of claim 7, wherein the low-voltage circuit further comprises an output inductor, a first end of the output inductor is electrically connected to the second end of the first low-voltage winding and the second end of the second low-voltage winding, and a second end of the output inductor is electrically connected to the output positive terminal.

10. A power conversion device, comprising:
an input positive terminal, an input negative terminal, an output positive terminal, an output negative terminal, a high-voltage circuit, and a low-voltage circuit,
wherein the input negative terminal and the output negative terminal are connected; the high-voltage circuit is connected across the input positive terminal and a connection point, and the low-voltage circuit is connected across the connection point and the output negative terminal;
the high-voltage circuit comprises a first high-voltage bridge arm, a second high-voltage bridge arm, a first input capacitor, and a high-voltage winding; the low-voltage circuit comprises a first low-voltage bridge arm, a second low-voltage bridge arm, a second input capacitor, a first low-voltage winding, a second low-voltage winding, and an output capacitor;
the power conversion device further comprises a transformer magnetic core, wherein the high-voltage winding, the first low-voltage winding and the second low-voltage winding are coupled by means of the transformer magnetic core; the transformer magnetic core comprises a first side and a third side opposite to each other; the first high-voltage bridge arm and the second high-voltage bridge arm of the high-voltage circuit are arranged adjacent to the first side of the transformer magnetic core; the first low-voltage bridge arm and the second low-voltage bridge arm of the low-voltage circuit are arranged adjacent to the third side of the transformer magnetic core;
the power conversion device further comprises a circuit board, wherein the circuit board comprises a top surface and a bottom surface opposite to each other, a hole and/or a hole groove, and the hole and/or the hole groove penetrate through the top surface and the bottom surface; the transformer magnetic core part passes through the hole and/or the hole groove and is assembled to the circuit board; and the wiring of the connection point is arranged on the circuit board and outside of the transformer magnetic core.

11. The power conversion device of claim 10, wherein the first high-voltage bridge arm and the second high-voltage bridge arm are connected in parallel and then connected between the input positive terminal and the connection point, and the first low-voltage bridge arm and the second low-voltage bridge arm are connected in parallel and then connected between the connection point and the input negative terminal;
each of the high-voltage bridge arms comprises two switches electrically connected in series; a first end of the high-voltage winding is electrically connected to a midpoint of the first high-voltage bridge arm, and a second end of the high-voltage winding is electrically connected to a midpoint of the second high-voltage bridge arm;
the first low-voltage bridge arm comprises a first main switch and a first lower switch electrically connected in series, and the first main switch and the first lower switch are electrically connected to a first lower node; the second low-voltage bridge arm comprises a second main switch and a second lower switch electrically connected in series, and the second main switch and the second lower switch are electrically connected to a second lower node;
a first end of the first low-voltage winding is electrically connected to the first lower node, a first end of the second low-voltage winding is electrically connected to the second lower node, and a second end of the first low-voltage winding is connected to a second end of the second low-voltage winding; and the first end of the high-voltage winding, the first end of the first low-voltage winding, and the second end of the second low-voltage winding have the same polarity.

12. The power conversion device of claim 11, wherein the circuit board comprises three holes, the three holes are sequentially arranged in the same direction, and a channel formed between every two adjacent holes is a first channel and a second channel, respectively;
two switches of the first high voltage bridge arm are disposed adjacent to the first channel, the first lower switch is disposed adjacent to the second channel, two switches of the second high voltage bridge arm are disposed adjacent to the second channel, and the second lower switch is disposed adjacent to the first channel.

13. The power conversion device of claim 12, wherein the two switches of the first high-voltage bridge arm are horizontally arranged along the X-axis or vertically arranged along the Y-axis, and the two switches of the second high-voltage bridge arm are horizontally arranged along the X-axis or vertically arranged along the Y-axis;
the first input capacitor is disposed on two opposite sides of two switches of the first high-voltage bridge arm and/or two opposite sides of two switches of the second high-voltage bridge arm, or the first input capacitor is disposed between the first high-voltage bridge arm and the second high-voltage bridge arm.

14. The power conversion device of claim 12, wherein the first input capacitor is disposed on the bottom surface of the circuit board, and a projection of the first input capacitor on the circuit board and a projection of the switch of the high-voltage circuit on the circuit board at least partially overlap.

15. The power conversion device of claim 10, wherein the power conversion device further comprises an output inductor, a first end of the output inductor is electrically connected to a second end of the first low-voltage winding and a second end of the second low-voltage winding, and a second end of the output inductor is electrically connected to an output positive terminal;
the power conversion device further includes an inductor magnetic core disposed adjacent to a third side of the transformer magnetic core.

16. The power conversion device of claim 11, wherein the first lower switch is disposed adjacent to the first main switch, and the second lower switch is disposed adjacent to the second main switch;
wherein the first lower switch is disposed between the transformer magnetic core and the first main switch, and the second lower switch is disposed between the transformer magnetic core and the second main switch.

17. The power conversion device of claim 16, wherein the second input capacitor is disposed adjacent to the first main switch and the first lower switch, and/or the second input capacitor is disposed adjacent to the second main switch and the second lower switch.

18. The power conversion device of claim 16, wherein the second input capacitor is disposed on the bottom surface of the circuit board, and a projection of the second input capacitor on the circuit board at least partially overlaps with a projection of the first main switch and the second main switch on the circuit board.

19. The power conversion device of claim 11, wherein both the first lower switch and the second lower switch comprise two switches connected in parallel, the two switches connected in parallel are respectively arranged on the top surface and the bottom surface of the circuit board, and projections of the two parallel switches on the circuit board at least partially overlap.

20. The power conversion device of claim 11, wherein the input positive terminal and the input negative terminal are disposed adjacent to two switches of the first high-voltage bridge arm and/or two switches of the second high-voltage bridge arm; and
the output positive terminal and the output negative terminal are disposed adjacent to the first main switch and/or the second main switch, and the output capacitor is disposed between the output positive terminal and the output negative terminal.
